(19) United States
(12) Patent Application Publication
(10) Pub. No.: US 2023/0393361 A1
(43) Pub. Date: Dec. 7, 2023

(54) Fiber Optic Cable, Connector, and Method of Assembly

(71) Applicant: PCT International, Inc., Tempe, AZ (US)

(72) Inventor: Timothy L. Youtsey, Tempe, AZ (US)

(73) Assignee: PCT International, Inc., Tempe, AZ (US)

(21) Appl. No.: 18/207,027

(22) Filed: Jun. 7, 2023

Related U.S. Application Data
(60) Provisional application No. 63/350,004, filed on Jun. 7, 2022.
(60) Provisional application No. 63/350,008, filed on Jun. 7, 2022.

(51) Int. Cl. G02B 6/44; G02B 6/38; H01R 9/05

(52) U.S. Cl. CPC G02B 6/4471; G02B 6/3802; G02B 6/3825; G02B 6/3898; H01R 9/0521

(57) ABSTRACT

A fiber optic cable assembly includes a fiber strand having a length extending proximally along an axis and terminating distally at a termination, and a ferrule proximate the termination, wherein the ferrule is frangible, configured to shear along the length of the fiber strand, inboard of the termination.

### CROSS-REFERENCE TO RELATED APPLICATIONS

This application claims the benefit of U.S. Provisional Application No. 63/350,004, filed Jun. 7, 2022, and of U.S. Provisional Application No. 63/350,008, filed Jun. 7, 2022, both of which are hereby incorporated by reference in their entireties.

### FIELD

The present specification relates generally to data communication, and more particularly to fiber optic data communication.

### BACKGROUND

Most telecommunication networks rely on hard-line outside installations. As with any equipment installed in an outside environment, these networks require maintenance. For decades, service technicians have rolled their trucks as needed to repair broken or old network telecommunications equipment.

As usage and demand have increased, telecommunications companies have improved their networks. Such networks once used twisted-pair wires to transmit small amounts of data slowly. Twisted-pair technology gave way to coaxial cable technology, vastly improving both the speed and bandwidth of data communication. Now, fiber optic lines are replacing coaxial cables.

While fiber optic technology is clearly superior in performance characteristics to coaxial and twisted-pair technology, it nevertheless presents some practical implementation challenges with respect to those older technologies. Twisted-pair wires and coaxial cables could be repaired or replaced fairly easily in the field. A technician would visit a work site, cut a damaged portion of a cable out, prepare and fit the cut ends with connectors, and then install a jumper between. Often, the technician created the jumper in the field by simply cutting a length of cable and fitting it with connectors at opposed free ends. Generally, technicians could perform these repairs consistently and reliably over and over again with a few pieces of hardware. As a result, technicians could carry a fairly limited variety of hardware and yet still be able to repair most equipment.

Optical fibers are much less forgiving than coaxial cables, however. The quality and performance of the telecommunications network often is dependent on—or is limited by—the quality of the connection between cables or between a cable and an optical device. The fibers must be cut very carefully and particularly or the cable will not operate. Because the optical fiber is very thin, it can be difficult to register and align the fiber within a connector properly. It is also quite difficult to cut an optical fiber with the precision required to maintain signal integrity. Moreover, fiber optic cables may be used with a variety of connectors, all ranging in size, shape, and specification. A technician out in the field may not be able to complete a repair or maintenance service if he does not have a suitable connector that will accommodate both the fiber optic cable he is carrying and the device to which the cable is being connected.

Moreover, the fibers can be quite dangerous. When fiber strands are cut, scraps of the fiber strand can break off and enter the skin or even the eye. If a fiber scrap penetrates the skin, it is extremely painful, difficult to see, and nearly impossible to remove. Generally, one will have to wait until the fiber scrap becomes infected and is pushed out by the body. And if a fiber scrap enters the eye, a trip to the emergency room is almost always required. Lastly, fiber optic connectors are just technically very difficult to install correctly on fiber strands. Expensive tooling, skilled technicians, and a great deal of safety equipment and handling is required to install or attach a fiber optic connector.

As a result, technicians usually do not create fiber optic jumpers on demand in the field.

Instead, manufacturers usually prepare jumpers in a factory or controlled setting at specific lengths. Most telecommunication companies prefer to purchase these pre-made fiber optic cable jumpers rather than have technicians prepare them in the field. This has its own complications, however. Purchasing pre-made jumpers results in higher cost and inventory management issues for multiple SKUs. It also requires fiber optic cable packaging management solutions after installation. Technicians are forced to carry a large variety of jumpers on their trucks, selecting from their personal inventory when they perform a repair. It is unlikely that any selected jumper will be just the right size and specification needed, so that the technician will usually have to “size up” and use a jumper that is too long, rather than too short. This means each technician must carry a large number of jumpers, and each telecommunication company has to purchase or source a huge number of jumpers at different lengths. This creates supply-chain, inventory, and waste issues for the telecommunication company.

A way to reliably and effectively prepare a fiber optic cable with a connector in the field is needed.

### SUMMARY

In an embodiment, a fiber optic cable assembly includes a fiber strand having a length extending proximally along an axis and terminating distally at a termination, and a ferrule proximate the termination, wherein the ferrule is frangible, configured to shear along the length of the fiber strand, inboard of the termination.

In some embodiments, the ferrule is segmented into multiple portions. The portions are arranged axially along the axis. The portions are characterized by a first diameter, and the portions are demarcated between adjacent portions by a second diameter which is less than the first diameter. The portions are demarcated by frangible couplings. The ferrule portions and the frangible couplings are a monolith. The ferrule is segmented into a proximal portion, an intermediate portion, and a distal portion, all arranged axially along the axis, the fiber strand extends through the proximal portion, and the termination is located distal to the proximal portion. In some embodiments, frangible couplings delineate or demarcate the proximal, intermediate, and distal portions, and the frangible couplings have a reduced diameter with respect to the proximal, intermediate, and distal portions. The frangible couplings have a blunt face and an opposed cone joined at a tip of the cone, the tip defining a stress concentration point.

In an embodiment, a method of preparing a fiber optic cable includes providing a fiber optic cable assembly including a fiber strand encased within a segmented ferrule, providing a tool for shearing the ferrule and the fiber strand, the tool including a set of jaws for holding the ferrule and a plunger for shearing a portion of the ferrule and fiber strand, fitting the fiber optic cable assembly in the jaws of the tool, and actuating the plunger to shear the portion of the ferrule and the fiber strand from the fiber optic cable assembly to form a prepared fiber optic cable with a prepared end of the fiber strand.

In some embodiments, the method includes the step of registering the portion of the ferrule and the fiber strand with the plunger of the tool. The ferrule is segmented by frangible couplings, and the method includes the step of registering the frangible couplings with the plunger of the tool. The method includes providing a fiber optic cable connector having an outer barrel, an inner post disposed within an interior of the outer barrel, and a coupling nut mounted over the inner post at a front end of the outer barrel, and applying the prepared fiber optic cable to the fiber optic cable connector. The method includes the step of registering the fiber optic cable with the inner post. The method includes the steps of advancing the prepared fiber optic cable with respect to the fiber optic cable connector so that the ferrule is received snugly within the inner post, and stopping the advancing of the fiber optic cable when the prepared end of the fiber strand is located within the coupling nut so as to be ready to couple with a fiber optic device in optical communication. In some embodiments, the step of stopping further includes stopping the advancing of the fiber optic cable when the prepared end of the fiber strand projects from the inner post into the coupling nut.

In an embodiment, a fiber strand preparation tool includes a vise assembly including opposed jaws, each including a semi-cylindrical channel, wherein the semi-cylindrical channels define a first bore. A plunger is mounted to the shaft to move between a retracted position and an advanced position, the plunger including a second bore. A lever is mounted for movement between an open position and a closed position, wherein movement of the lever from the open position to the closed position imparts movement to the plunger from the retracted position to the advanced position. Movement of the plunger from the retracted position to the advanced position moves the second bore from alignment with the first bore to out of alignment with the first bore. In some embodiments, the plunger is flanked by the jaws.

In an embodiment, a fiber optic cable connector includes an outer barrel having a front end, a rear end, a longitudinal axis, and an interior. An inner post is disposed within the interior, the inner post configured to receive a fiber strand, wherein the fiber strand is encased within a ferrule extending proximally to a plug and the fiber strand has a prepared distal end. A coupling nut is mounted over the inner post at the front end of the body. When the fiber strand is fully inserted into the inner post, the prepared end of the fiber strand is located within the coupling nut so as to be ready to couple with a fiber optic device in optical communication. In some embodiments, when the fiber strand is fully inserted into the inner post, the prepared end of the fiber strand projects from the inner post into the coupling nut.

The above provides the reader with a very brief summary of some embodiments described below. Simplifications and omissions are made, and the summary is not intended to limit or define in any way the disclosure. Rather, this brief summary merely introduces the reader to some aspects of some embodiments in preparation for the detailed description that follows.

### BRIEF DESCRIPTION OF THE DRAWINGS

Referring to the drawings:

FIG. 1 is a perspective view of a fiber optic cable assembly;

FIG. 2 is a section view of the fiber optic cable assembly taken along the line 2-2 in FIG. 1;

FIG. 3 is a perspective view of a tool for preparing the fiber optic cable assembly for application with a connector;

FIG. 4 is a section view of the preparation tool taken along the line 4-4 in FIG. 3;

FIG. 5 is a perspective view of a connector applied to a fiber optic cable;

FIG. 6 is an exploded view of the connector and the fiber optic cable of FIG. 5; and

FIG. 7 is a section view of the connector and fiber optic cable taken along line 7-7 in FIG. 5.

### DETAILED DESCRIPTION

Reference now is made to the drawings, in which the same reference characters are used throughout the different figures to designate the same elements. Briefly, the embodiments presented herein are preferred exemplary embodiments and are not intended to limit the scope, applicability, or configuration of all possible embodiments, but rather to provide an enabling description for all possible embodiments within the scope and spirit of the specification. Description of these preferred embodiments is generally made with the use of verbs such as “is” and “are” rather than “may,” “could,” “includes,” “comprises,” and the like, because the description is made with reference to the drawings presented. One having ordinary skill in the art will understand that changes may be made in the structure, arrangement, number, and function of elements and features without departing from the scope and spirit of the specification. Further, the description may omit certain information which is readily known to one having ordinary skill in the art to prevent crowding the description with detail which is not necessary for enablement. Indeed, the diction used herein is meant to be readable and informational rather than to delineate and limit the specification; therefore, the scope and spirit of the specification should not be limited by the following description and its language choices.

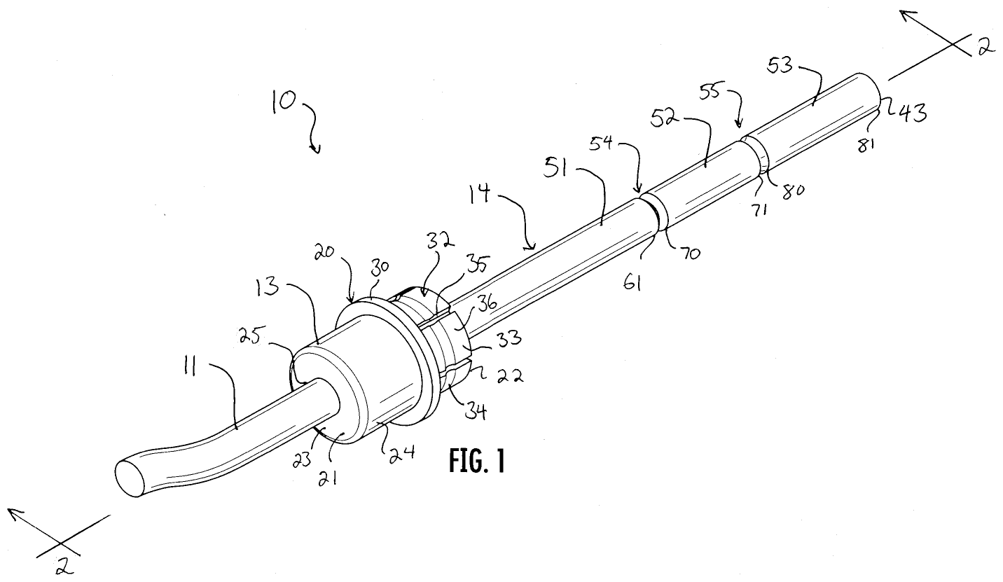

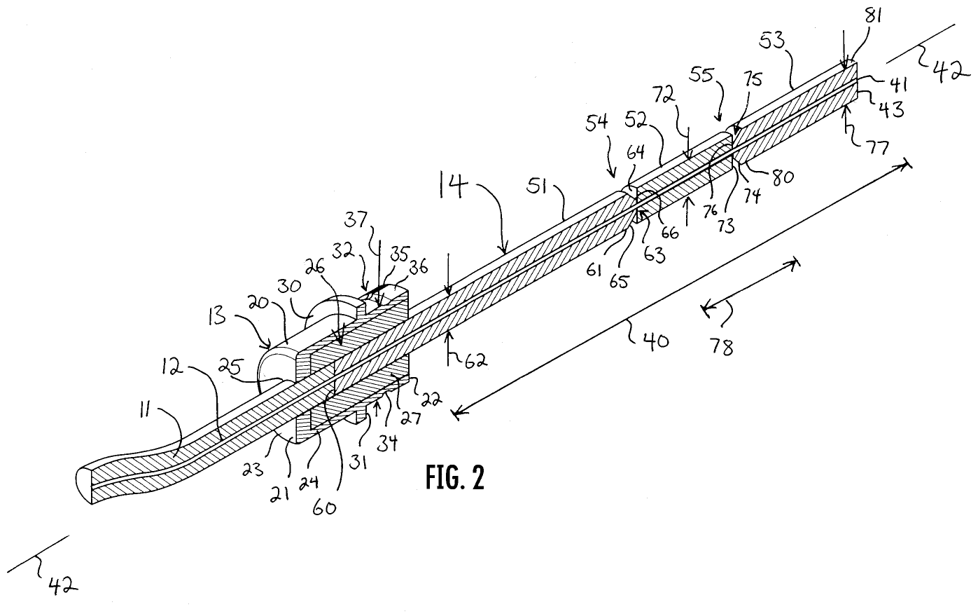

FIG. 1 illustrates a perspective view of a fiber optic cable assembly 10. FIG. 2 is a section view of the fiber optic cable assembly 10 taken along the line 2-2 in FIG. 1. The fiber optic cable assembly 10 includes a flexible jacket 11 surrounding a fiber strand 12 up to a retainer 13. A ferrule 14 extends beyond the retainer 13 and encases the fiber strand 12. This fiber optic cable assembly 10 has been prepared so that a technician can cleave it and apply a connector on to it. Once a connector has been applied, the technician can easily couple the fiber optic cable assembly 10 to another fiber optic device, such as another cable, a port, network equipment, etc.

The fiber strand 12 is an optical fiber strand. It is made from a thin strand or strands of glass or plastic clad within an outer layer of glass. Pulsed light transmitted from a proximal end travels down the fiber strand 12, bouncing off the interior cladding wall. The jacket 11 surrounds the fiber strand 12 and protects it. The jacket 11 extends up to and into the retainer 13.

The retainer 13 has a roughly cylindrical outer body 20 with a rear, or proximal, end 21 and an opposed front, or distal, end 22. The outer body 20 has an endwall 23 at the proximal end 21 and a cylindrical sidewall 24 extending forwardly from the endwall 23 to the distal end 22. The endwall 23 and sidewall 24 define the outer body 20 as a monolithic structure, formed integrally as one piece.

The endwall 23 is disc-shaped and has a central bore 25 through which the jacket 11 and fiber strand 12 extend. The sidewall 24 has an inner surface bounding and defining an interior 26 that extends to an open mouth at the distal end 22. The fiber strand 12 extends entirely through the interior 26 continuously and without interruption. The jacket 11, however, extends only partly into the interior 26 past the endwall 23.

The jacket 11 terminates in abutting relationship with the ferrule 14 within the interior 26. The ferrule 14 extends from within the interior 26, through the open mouth at the distal end 22, and beyond the retainer 13. An annular spacer or block 27 surrounds the ferrule 14 within the interior 26. The block 27 is snug fit between the inner surface of the sidewall 24 and the outer surface of the ferrule 14. The block 27 extends from the endwall 23 to the mouth at the distal end 22 of the retainer 13. The block 27 assists in holding the jacket 11 and the ferrule 14 in place in the retainer 13. The block 27 is preferably rigid, and may be constructed from a hard, rigid material such as a ceramic. In some embodiments, the block 27 is integral or monolithic to the ferrule 14 itself.

The sidewall 24 includes a flange 30. The flange 30 is annular, extending radially outward from the sidewall 24. The flange 30 is formed integrally to the sidewall 24 and is monolithic to the cylindrical body 20. The flange 30 is located in a generally intermediate position between the proximal and distal ends 21 and 22 of the body 20. The flange 30 includes an annular front face 31.

Distal to the flange 30, the sidewall 24 defines a collet 32. Briefly, the terms “proximal” and “distal” are used herein to refer to directions, relative directions, locations, relative locations, and arrangements and relative arrangements. As seen from the discussion so far with respect to the retainer 13, “proximal” is meant to indicate the rear, toward the rear, or closer to the rear, while “proximal” is meant to indicate the front, toward the front, or closer to the front, as the context may indicate. Generally, the free end of the fiber strand 12 is the most distal structure. For example, a first part which is “distal” to a second part is closer to the free end of the fiber strand 12 than is the first part. A third part which is “proximal” to a fourth part is behind the fourth part, or further from the end of the fiber strand 12 than is the fourth part. Thus, the collet 32 is distal to the flange 30.

The collet 32 is sized and shaped to engage with the rear end of a connector, as is described below. The collet 32 includes the annular sidewall 24 projecting forwardly. The collet 32 has a generally cylindrical outer surface 33 between the flange 30 and the distal end 22 of the retainer 13. A circumferential channel 34 extends into the outer surface 33, just inboard of the distal end 22.

The collet 32 includes axial slots 35 formed therein which allow compression of the collet 32 and the sidewall 24 proximate the distal end 22 of the retainer 13. The slots 35 extend from the distal end 22 back to the flange 30. The slots 35 define fingers 36 of the collet 32, which fingers 36 are flexible and structured to flex in a radial direction. This allows the retainer 13 to engage with a connector.

Projecting forwardly from the retainer 13, the fiber strand 12 is encased within the ferrule 14. The fiber strand 12 has a length 40 from the retainer 13 to a termination 41 at the free end of the fiber strand 12. The ferrule 14 has a distal end 43. In some embodiments, the termination 41 may extend beyond the distal end 43 of the ferrule 14, however, preferably, the termination 41 of the fiber strand 12 is at the distal end 43 of the ferrule 14 or inboard of the distal end 43 of the ferrule.

In embodiments in which a factory or manufacturer prepares the fiber optic cable assembly 10, the termination 41 may very well be inboard of the distal end 43 of the ferrule 14 to prevent accidental injury from the exposed fiber strand 12. For the purposes of this exemplary description, however, the illustrations show the fiber strand 12 extending and terminating the same distance from the retainer 13 as the ferrule 14.

The fiber strand 12 is slender and has a longitudinal axis 42 extending along its length 40. Along that length 40, within the ferrule 14, the fiber strand 12 is linear along the axis 42. The axis 42 is defined by the shape of the fiber strand 12 within the ferrule 14 and along its length 40, but the axis 42 nevertheless extends both proximally and distally beyond the length 40, even where the fiber strand 12 is not arranged linearly.

The ferrule 14 is frangible, configured to shear along the length 40 of the fiber strand 12, inboard of its termination 41. The ferrule 14 is a ceramic encasement over the fiber strand 12 which protects and assists the technician in preparing the fiber strand 12 for application to a connector.

Still referring to FIGS. 1 and 2, the ferrule 14 is segmented and includes multiple adjacent portions arranged axially along the axis 42: a proximal portion 51, an opposed distal portion 53, and an intermediate portion 52 therebetween. The three portions form a monolith; they are formed integrally to each other as a unitary, integral, monolithic, single piece. The fiber strand 12 extends through the ferrule 14, through the proximal portion 51, and at least partially into the intermediate portion 52. In the embodiment shown here, the fiber strand 12 extends all the way to the distal end of the ferrule 14, but in other embodiments, the fiber strand 12 terminates short of that distal end. Although they define a monolith, the three portions 51, 52, and 53 are, nevertheless demarcated or delineated by discontinuities between the portions 51, 52, and 53. These are frangible couplings 54 and 55 connecting the portions 51, 52, and 53.

The proximal portion 51 of the ferrule 14 is generally cylindrical. It includes a proximal end 60 and an opposed distal end 61. The proximal end 60 is secured within the interior 26 of the retainer 13. The distal end 61 is formed integrally to the intermediate portion 52 of the ferrule 14, through the first frangible coupling 54. Between the proximal and distal ends 60 and 61, the proximal portion 51 preferably has a cylindrical body characterized by a constant first outer diameter 62. The distal end 61 of the proximal portion 51 is formed integrally to the first frangible coupling 54.

The first frangible coupling 54 includes a blunt face 64 and an opposed cone 65. The blunt face 64 and cone 65 are joined integrally to each other. The first frangible coupling 54 includes the cone 65 and has a reduced diameter tapering inward from the outer diameter 62 to a second, non-zero outer diameter 63 at a tip 66 of the cone 65. The second outer diameter 63 is concentric to and smaller than the first outer diameter 62. The tip 66, the juncture of the cone 65 and the blunt face 64, is a stress concentration point; force applied near the proximal and/or intermediate portions 51 and 52 is likely to cause a fracture, break, or shearing at the tip 66. Thus, the first frangible coupling 54 is designed to break, and the ferrule 14 is frangible along the length 40 of the fiber strand 12 inboard of the termination 41.

The intermediate portion 52 of the ferrule 14 is generally cylindrical. It includes opposed proximal and distal ends 70 and 71 which are each preferably blunt. The blunt face 64 of the first frangible coupling 54 is at the proximal end 70. Similarly, a blunt face of the frangible coupling 55 is at the distal end 71. Between the ends 70 and 71, the intermediate portion 52 has a generally cylindrical body with a length 78 and a third outer diameter 72. The third outer diameter 72 is preferably constant entirely between the ends 70 and 71, and is preferably equal to the first diameter 62 of the proximal portion 51. The intermediate portion 52 is preferably coaxial to the proximal portion 51, formed along the common axis 42. The distal end 61 of the proximal portion 51 of the ferrule 14 is formed integrally to the second frangible coupling 55.

The second frangible coupling 55 includes a blunt face 73 and an opposed cone 74. The blunt face 73 is at the distal end 61 of the intermediate portion 52. The blunt face 73 and opposed cone 74 are joined integrally to each other. The second frangible coupling 55 includes the cone 74 and has a reduced diameter tapering outward from a non-zero fourth outer diameter 75 at a tip 76 of the cone 74 to a fifth outer diameter 77 along the distal portion 53. The fourth diameter 75 is concentric to but smaller than the fifth diameter 77. The tip 76, the juncture of the blunt face 73 and the cone 74, is a stress concentration point; force applied near the intermediate and/or distal portions 52 and 53 is likely to cause a fracture, break, or shearing at the tip 76. Thus, the second frangible coupling 55 is designed to break, and the ferrule 14 is frangible along the length 40 of the fiber strand 12 inboard of the termination 41.

The distal portion 53 of the ferrule 14 is generally cylindrical. It includes a proximal end 80 and an opposed distal end 81. The proximal end 80 is formed integrally to the intermediate portion 52 of the ferrule 14, through the second frangible coupling 55. The distal end 81 is preferably blunt, coincident with the distal end 43 of the entire ferrule 14. Between the proximal and distal ends 80 and 81, the distal portion 53 preferably has a cylindrical body with the constant fifth outer diameter 77. The distal portion 53 is coaxial to the intermediate portion 52 and the proximal portion 51, as each is formed along the axis 42. The fifth outer diameter 77 is preferably equal to the first and third outer diameters 62 and 72.

The ferrule 14 is segmented between the proximal and intermediate portions 51 and 52 and between the intermediate and distal portions 52 and 53, but it is preferably not severed between those portions. Rather, as an integral part of the assembly 10, the ferrule 14 is a single-body, unitary and monolithic piece encasing the fiber strand 12. The ferrule 14 is segmented because the first and second frangible couplings 54 and 55 delineate and demarcate the proximal portion 51 and the distal portion 53 from the intermediate portion 52. As such, the proximal and intermediate portions 51 and 52 are adjacent to each other, and the intermediate and distal portions 52 and 53 are adjacent each other. Although manufactured and delivered as a monolithic structure, the fiber optic cable assembly 10 is meant to be severed or separated. By doing so, a technician is able to convert the fiber optic cable assembly 10 into a prepared fiber optic cable for use in creating a fiber optic jumper for a field repair.

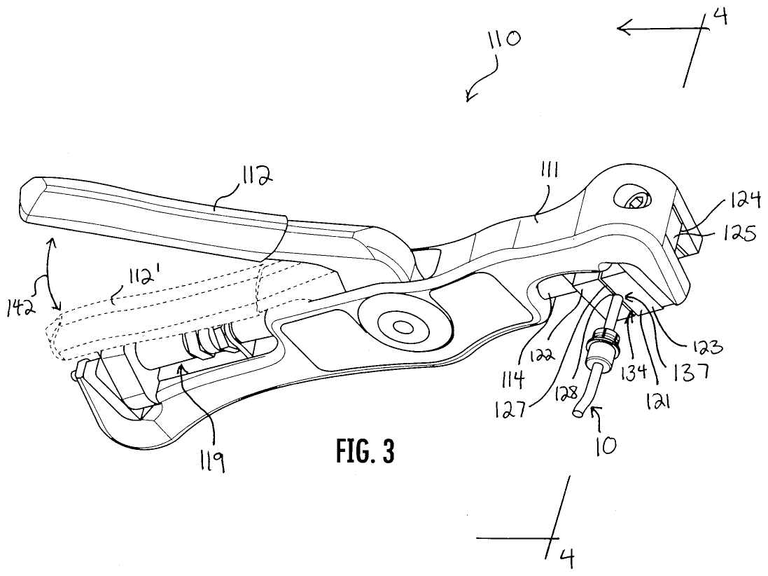

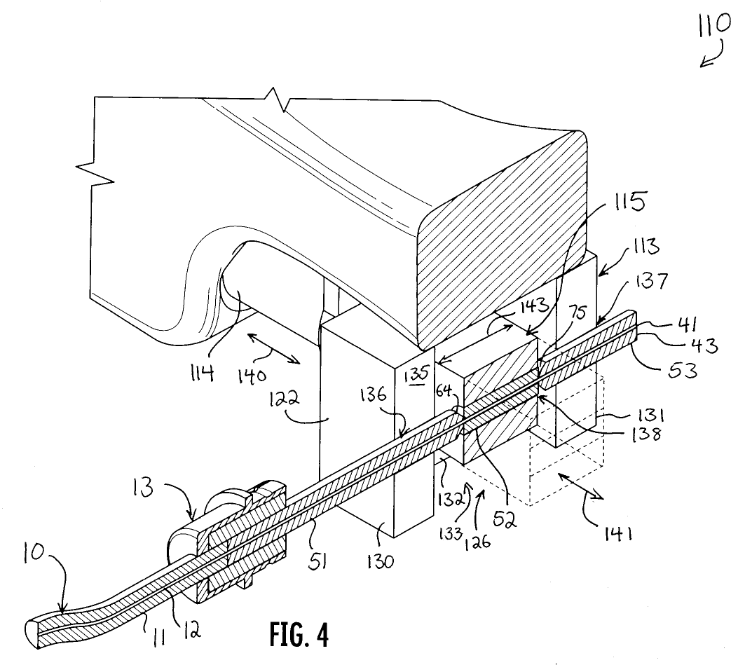

To separate the portions 51, 52, and 53, the technician uses the preparation tool 110, shown in FIGS. 3 and 4. The tool 110 includes a body 111 having a lever 112 at one end, a vise assembly 113 at an opposed end, and a ram 114 disposed therebetween for moving a plunger 115 within the vise assembly 113. The vise assembly 113 includes jaws for accepting, receiving, and holding the fiber optic cable assembly 10, as shown in FIGS. 3 and 4. The tool 110 enables a technician to quickly register the fiber optic cable assembly 10 and cleave the ferrule 14 so that a connector can be placed over the fiber optic cable assembly 10. The tool 110 also includes another assembly 119 for preparing other telecommunications devices, or for compressing a connector onto the fiber optic cable assembly 10 after it has been prepared by the plunger 115.

The vise assembly 113 includes two opposed jaws 121 and 122. The jaws 121 and 122 are strong and rigid structures, are of any suitable thickness, and are constructed from a material or combination of materials having strong, hard, rigid, and durable material characteristics, such as some metals. The jaws 121 and 122 are configured to provide a stable and uniform brace for the ferrule 14.

The first jaw 121 is fixed to the body 111 on the other side of the second jaw 122 from the ram 114. The first jaw 121 has two opposed side blocks 123 and 124 connected to each other by a solid endwall 125. The blocks 123 and 124 flank a void 126 (visible only in FIG. 4), and the blocks 123 and 124 cooperate with the endwall 125 to bound one side of that void 126. The void 126 is an area into which the intermediate portion 52 is pushed during the cleaving operation.

The second jaw 122 is preferably also mounted to the body 111. The second jaw 122 has two opposed side blocks 130 and 131 connected to the each other by a solid endwall 132. The blocks 130 and 131 flank a void 133, and the blocks 130 and 131 cooperate with the endwall 132 to bound one side of that void 133. The void 133 is the area through which the plunger 115 moves to cleave the intermediate portion 52 of the ferrule 14.

The side block 123 is preferably coextensive to, opposed to, and registered with the side block 130, and the side block 124 is preferably coextensive to, opposed to, and registered with the side block 131. In this embodiment, the side blocks 123 and 124 are slightly spaced apart from the side blocks 130 and 131, respectively. In other embodiments, there is no separation, and the first and second jaws 121 and 122 are formed integrally to each other, such that the vise assembly 113 is a single piece. In this embodiment, though, a slight gap 134 is formed between the two jaws 121 and 122. The voids 126 and 133 in the jaws 121 and 122 are registered with each other and form one large void within the vise assembly 113.

The first jaw 121 has a flat face 127 across the side blocks 123 and 124, and the face 127 is directed toward the second jaw 122. The face 127 has a roughly semi-cylindrical channel 128 formed into it. The channel 128 extends laterally across the face 127.

The second jaw 122 also has a flat face 135 across the side blocks 130 and 131. The face 135 is directed toward the first jaw 121 and has a roughly semi-cylindrical channel 136 formed into it. The channel 128 is registered with the channel 136 and extends laterally across the face 135. So registered, the channels 128 and 136 define a roughly cylindrical bore 137 corresponding in inner diameter to the first, third, and fifth outer diameters 62, 72, and 77 of the ferrule 14. The bore 137 is just large enough to closely receive the ferrule 14.

The plunger 115 also includes a cylindrical bore 138 registered with the bore 137. The plunger 115 is a solid block mounted on an end of the ram 114. The plunger 115 has a width 143, and the bore 138 extends entirely through that width 143. The ram 114 is mounted for reciprocal movement along the line 140 shown in FIG. 4, and the plunger 115 is mounted for reciprocal movement along the line 141 shown in FIG. 4 in response to the movement of the ram 114. The plunger 115 is flanked by the jaws 121 and 122 and moves reciprocally between them.

The ram 114 is a generally cylindrical shaft. The ram 114 is mounted within a bore in the body 111 of the tool 110 for its reciprocal movement. At one end, the plunger 115 is fixed on the ram 114. At the other end, a linkage couples the ram 114 to the lever 112. The linkage is concealed within the body 111 of the tool 110. The linkage rocks. When the lever 112 is in an open position (as shown by the reference character 112 in FIG. 1), the linkage is drawn back and the ram 114 is drawn back into a retracted position. When the lever 112 moves along the arcuate line 142 into a closed position (as shown in broken line and with the reference character 112′ in FIG. 1), the linkage is forced forward and pushes the ram 114 into an advanced position.

FIGS. 3 and 4 show the ram 114 in the retracted position, and so the plunger 115 is also in its retracted position. In the retracted position of the plunger 115, the bore 138 in the plunger 115 is coaxially aligned with the bore 137 of the vise assembly 113. As such, the aligned bores 137 and 138 can receive the ferrule 14 for proper registration before cleaving.

FIGS. 3 and 4 show the tool 110 with the fiber optic cable assembly 10 applied thereto, just as would happen in the field. In the field, a technician will pull a length of the fiber optic cable assembly 10 fit with the retainer 13 and the ferrule 14 and place it into the tool 110. First, the technician ensures that the lever 112 is in the open position, which moves the ram 114 and the plunger 115 into their retracted positions. The plunger 115 is thus registered so that the bores 137 and 138 are aligned with each other and ready to receive the fiber optic cable assembly 10.

The technician introduces the fiber optic cable assembly 10 into the bore 137, passing the termination 41 and distal end 43 into the bore 137 first. The technician continues passing the fiber optic cable assembly 10 into the bores 137 and 138 until the distal end 43 is visible outside the side blocks 131 and 124. The technician then slides the fiber optic cable assembly 10 proximally or distally so that the intermediate portion 52 is registered with the plunger 115. When properly registered, the intermediate portion 52 is entirely within bore 138. The intermediate portion 52 has a length 78 which is equal to the width 143 of the intermediate portion 52. In some embodiments, the tool 110 has markings or other indications to indicate proper alignment of the ferrule 14 within the tool 110. However, in most cases, the technician can simply invert the tool 110 and look into the voids 126 and 133 to sight the ferrule 14. If the intermediate portion 52 is not visible, the ferrule 14 is properly registered. Or, if the technician can see only the cones 65 and 74 just outside the plunger 115, the ferrule 14 is properly registered. FIG. 4 illustrates this proper registration.

When the ferrule 14 is properly registered in the tool 110, the technician moves the lever 112 from the open position to the closed position (as indicated in broken line and by reference character 112′). This imparts forward movement to the ram 114 into its advanced position, which in turn imparts movement to the plunger 115 into its advanced position (shown in FIG. 4 in broken line). Movement of the plunger 115 from its retracted position to its advanced position moves the bore 138 in the plunger 115 from a position of alignment with the bore 137 in the vise assembly 113 to a position out of alignment with the bore 137. The intermediate portion 52 is captured in the bore 138 in the plunger 115, however, and so movement of the plunger 115 applies a great shear force on the intermediate portion 52.

The first and second frangible couplings 54 and 55 are at the edges of the plunger 115. The blunt faces 64 and 73 of the frangible couplings 54 and 55 are preferably aligned with the edges of the plunger 115. The tips 66 and 76 of the cones 65 and 74 of the frangible couplings 54 and 55 are just outside the plunger 115, and the cones 65 and 74 are directed inward toward each other and toward the plunger 115. As such, the stress concentration points of the junctures at the tips 66 and 76 are just outside the edges of the plunger 115. When the plunger 115 moves, the shear force it exerts on the intermediate portion 52 is concentrated at the tips 66 and 76, and that is where cleaving is most likely to consistently occur.

The plunger 115 shears the intermediate portion 52 of the ferrule 14 cleanly, precisely, and consistently, severing both the ceramic ferrule 14 and the fiber strand 12 within. Once the intermediate portion 52 of the ferrule 14 has been sheared off, it falls out of the tool 110, likely through one of the voids 126 or 133. The distal portion 53 falls out of the tool 110 as well.

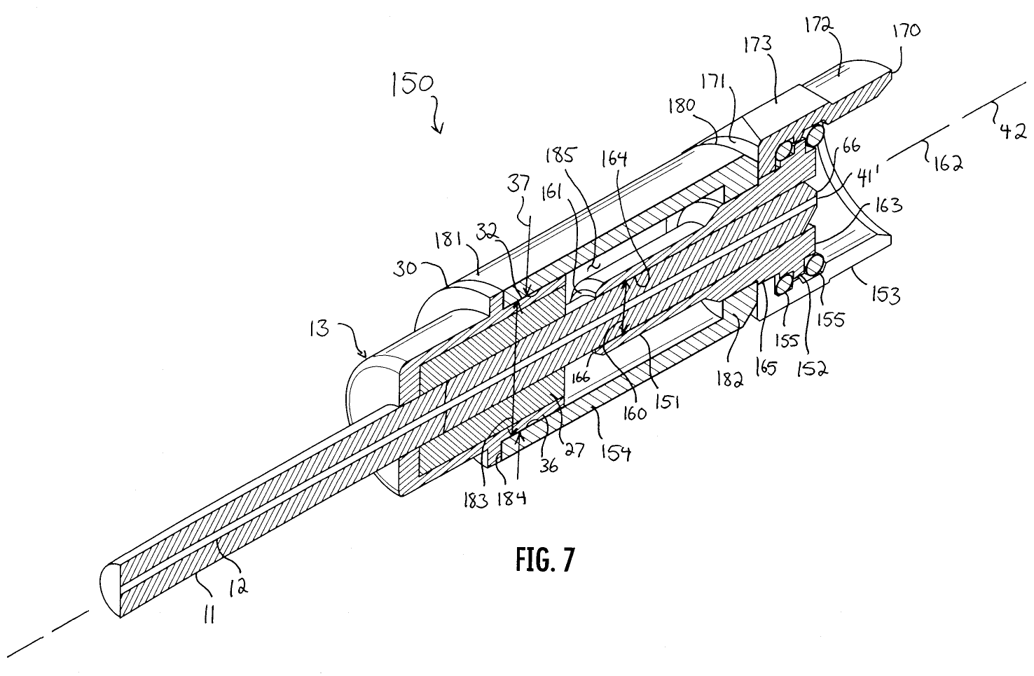

The technician then removes the sheared fiber optic cable assembly 10 from the tool 110. The intermediate portion 52 has sheared cleanly from the proximal and distal portions 51 and 53, leaving the tip 66 on the proximal portion 51 bare and smooth. The proximal portion 51 remains attached to the fiber strand 12 all the way back to the retainer 13. The fiber strand 12 now has a new termination 41′ (shown later in FIG. 7) where the plunger 115 sheared the fiber strand 12; the fiber strand 12 thus has a “prepared end” which is ready to be coupled in optical communication with an optical device.

The tip 66 is at the narrow end of the cone 65 and exposes the fiber strand 12 safely surrounded by the coned ferrule 14. The fiber strand 12 is oriented axially with the ferrule 14, and the end of the fiber strand 12 is normal to the axis 42. The tip 66 of the ferrule 14 presents a precisely-cut terminal end of the fiber strand 12, ready to be fit into a connector or otherwise installed as a jumper in the field. This defines a “prepared fiber optic cable 10′,” because the prepared fiber optic cable 10′ is ready for application with a connector.

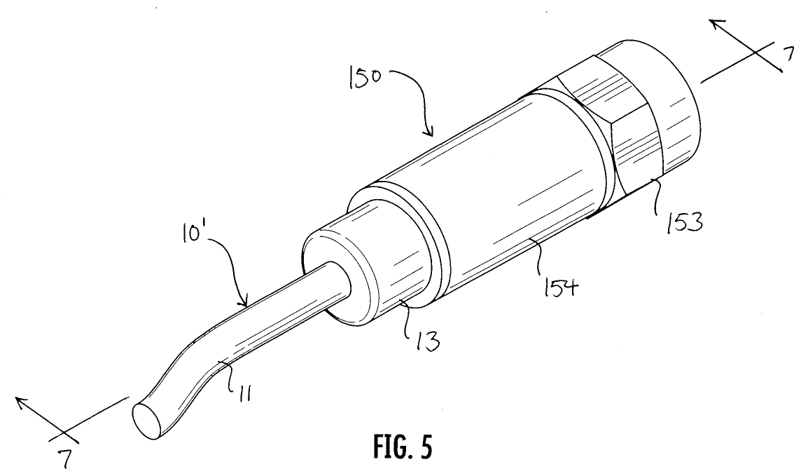

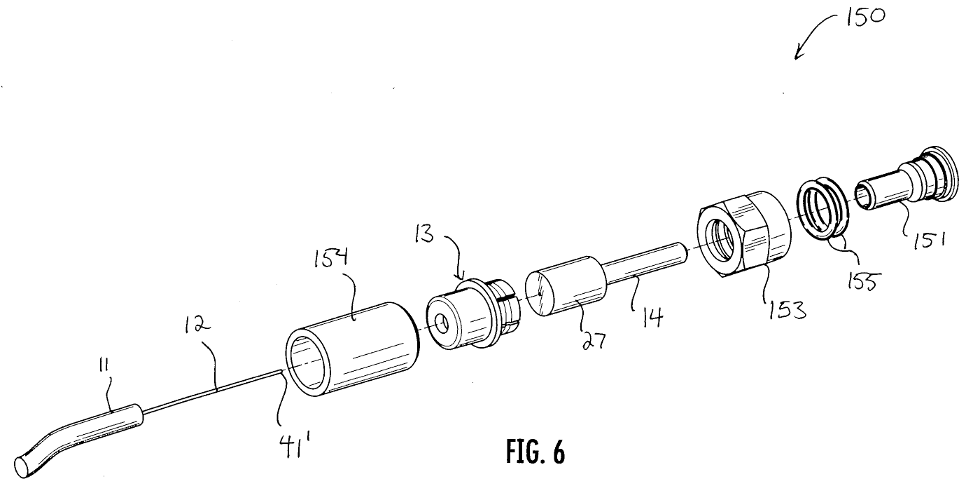

FIG. 5 is a perspective view of a connector 150 fit onto the prepared fiber optic cable 10′. FIG. 6 is an exploded view of the connector 150 and the cable 10′, and FIG. 7 is a section view taken along the line 7-7 in FIG. 5. The connector 150 is suitable for use with a wide variety of fiber optic cables and allows them to be connected to a variety of optical devices. This is but one exemplary description of a connector 150 suitable for use with the prepared fiber optic cable 10′. Other connectors are also suitable and are considered to be included within the scope of this disclosure.

The connector 150 includes an inner post 151 with a forward end having a radially-outwardly extending flange 152, a coupling nut 153 fit onto the forward end of the inner post 151, and a body or outer barrel 154 also fit on the inner post 151 and extending rearward behind the coupling nut 153. Gaskets 155 are carried for compression between the coupling nut 153 and the inner post 151.

The inner post 151 is an elongate, cylindrical sleeve extending along an axis 162 and having rotational symmetry about the axis 162. The inner post 151 extends back to a rear end 161 located within the outer barrel 154, and has an opposed front end 163 disposed within the coupling nut 153. Both the rear and front ends 161 and 163 are open.

The inner post 151 includes a smooth, cylindrical inner surface 164 and an opposed outer surface. The inner surface 164 of the inner post 151 defines an internal diameter 160 which is constant from the rear end 161 to the front end 163. The outer surface, however, is irregular and tiered, such that the inner post 151 has a sidewall thickness that changes between the rear and front ends 161 and 163.

The inner post 151 has a shoulder 165 that projects radially outward proximate the front end 163. In this embodiment, the shoulder 165 has two tiered surfaces with slightly different outer diameters. The flange 152 projects radially outward distal to the shoulder 165.

The coupling nut 153 is a sleeve having open and opposed front and rear ends 170 and 171, an integrally-formed ring portion 172 proximate the front end 170, and an integrally-formed nut portion 173 proximate the rear end 171. The ring portion 172 has a smooth annular outer surface, while the nut portion 173 preferably has a hexagonal outer surface to receive jaws of a tool. The inner surface of the ring portion 172 may be threaded or unthreaded, to allow for threaded engagement or push-on engagement with a mating port of an optical device. The inner surface of the nut portion 173 is grooved to receive the gaskets 155.

The rear end 171 of the coupling nut 153 rides on the outer surface of the inner post 151 for rotational movement. The gaskets 155 are interposed between the inner post 151 and the coupling nut 153, form a bearing surface between the two, and prevent moisture and other environmental ingress into the connector 150.

The outer barrel 154 is an elongate, cylindrical sleeve having opposed front and rear ends 180 and 181. It is mounted on the inner post 151 and extends along the axis 162 of the inner post 151. The outer barrel bounds an interior 185, and most of the inner post 151 is within the interior 185. The outer barrel 154 includes a flange 182 extending radially inward at the front end 180. The front end 180 is mounted tightly on the shoulder 165 of the inner post, such that the outer barrel 154 and inner post 151 are fixed to each other. At the rear end 181, the outer barrel 154 has an inner diameter 183.

The rear end 181 of the outer barrel 154 defines an open mouth 184 for receiving the prepared fiber optic cable 10′. The rear end 161 of the inner post 151 is also an open mouth 166 for receiving the prepared fiber optic cable 10′.

In operation, a technician grasps the outer barrel 154 of the connector 150 in one hand and grasps the prepared fiber optic cable 10′ with the other hand. He aligns the ferrule 14 with the open mouth of the outer barrel 154 of the connector 150 and advances the prepared fiber optic cable 10′ through the mouth 184 and into the interior 185 of the outer barrel 154. He continues advancing the ferrule 14, registering it with the inner post 151, and then fitting it within the mouth 166 of the inner post 151 to insert it into the inner post 151. The outer diameter 62 of the ferrule 14 corresponds to the inner diameter of the inner post 151, so that the ferrule 14 is snugly received therein.

He advances the ferrule 14 as the retainer 13 approaches the mouth 184, when the collet 32 is registered just outside the mouth 184. In some cases, the technician may be able to press the collet 32 into the mouth by hand, while in other cases, the technician may need to use a compression tool to further install the retainer 13 into the connector 150. Either way, the outer diameter of the collet 32 corresponds to the inner diameter 183 of the outer barrel 154. When the collet 32 is pressed against the mouth 184, the mouth 184 tightly receives the collet 32. In some embodiments, the technician will compress or crimp the connector 150 onto the collet 32 of the retainer 13.

By applying sufficient axial force on the retainer 13 against the mouth 184 of the outer barrel 154, the technician forces the retainer 13 into the interior 185, further advancing the ferrule 14 within the inner post 151.

The technician stops advancing once the tip 66 of the prepare fiber optic cable 10′ is just slightly beyond the front end 163 of the inner post 151, thereby placing the termination 14′ of the fiber strand 12 in the open interior of the coupling nut 153 forward of the inner post 151. In other words, the fiber strand 12 is fully inserted into the inner post 151 so that the prepared end of the fiber strand 12 projects from the inner post 151 into the coupling nut 152 and is ready to couple with an optical device in optical communication.

Now, the fiber strand 12 is coaxially aligned with the coupling nut 153 of the connector 150. The technician can easily apply the connector 150 over another fiber optic connector or over a mating port of an optical device and secure the connector 150 thereon. Doing so establishes a reliable optical communication connection between the fiber strand 12 and the optical device.

A preferred embodiment is fully and clearly described above so as to enable one having skill in the art to understand, make, and use the same. Those skilled in the art will recognize that modifications may be made to the description above without departing from the spirit of the specification, and that some embodiments include only those elements and features described, or a subset thereof. To the extent that modifications do not depart from the spirit of the specification, they are intended to be included within the scope thereof.

What is claimed is:

1. A fiber optic cable assembly comprising:
a fiber strand having a length extending proximally along an axis and terminating distally at a termination; and
a ferrule encasing the fiber strand;
wherein the ferrule is frangible, configured to shear along the length of the fiber strand, inboard of the termination.

2. The fiber optic cable assembly of claim 1, wherein the ferrule is segmented into multiple portions.

3. The fiber optic cable assembly of claim 2, wherein the portions are arranged axially along the axis.

4. The fiber optic cable assembly of claim 3, wherein:
the portions are characterized by a first diameter; and
the portions are demarcated between adjacent portions by a second diameter which is less than the first diameter.

5. The fiber optic cable assembly of claim 2, wherein the portions are demarcated by frangible couplings.

6. The fiber optic cable assembly of claim 5, wherein the portions and the frangible couplings comprise a monolith.

7. The fiber optic cable assembly of claim 1, wherein:
the ferrule is segmented into a proximal portion, an intermediate portion, and a distal portion, all arranged axially along the axis;
the fiber strand extends through the proximal portion; and
the termination is located distal to the proximal portion.

8. The fiber optic cable assembly of claim 7, further comprising:
frangible couplings delineating the proximal, intermediate, and distal portions; and
the frangible couplings have a reduced diameter with respect to the proximal, intermediate, and distal portions.

9. The fiber optic cable assembly of claim 8, wherein the frangible couplings have a blunt face and an opposed cone joined at a tip of the cone, the tip defining a stress concentration point of the ferrule.

10. A method of preparing a fiber optic cable, the method comprising:
providing a fiber optic cable assembly comprising a fiber strand encased within a segmented ferrule;
providing a tool for shearing the ferrule and the fiber strand, the tool comprising a set of jaws for holding the ferrule and a plunger for shearing a portion of the ferrule and the fiber strand;
fitting the fiber optic cable assembly in the jaws of the tool;
moving the plunger to shear the portion of the ferrule and the fiber strand from the fiber optic cable assembly to form a prepared fiber optic cable with a prepared end of the fiber strand.

11. The method of claim 10, further comprising registering the portion of the ferrule and the fiber strand with the plunger of the tool.

12. The method of claim 10, wherein the ferrule is segmented by frangible couplings, and further comprising the step of registering the frangible couplings with the plunger of the tool.

13. The method of claim 10, further comprising:
providing a fiber optic cable connector comprising an outer barrel, an inner post disposed within an interior of the outer barrel, and a coupling nut mounted over the inner post at a front end of the outer barrel;
applying the prepared fiber optic cable to the fiber optic cable connector.

14. The method of claim 13, further comprising registering the fiber optic cable with the inner post.

15. The method of claim 13, further comprising:
advancing the prepared fiber optic cable with respect to the fiber optic cable connector so that the ferrule is received snugly within the inner post; and
stopping the advancing of the prepared fiber optic cable when the prepared end of the fiber strand is located within the coupling nut so as to be ready to couple with a fiber optic device in optical communication.

16. The method of claim 15, wherein the step of stopping further includes stopping the advancing of the fiber optic cable when the prepared end of the fiber strand projects from the inner post into the coupling nut.

17. A fiber strand preparation tool comprising:
a vise assembly including opposed jaws, each including a semi-cylindrical channel, wherein the semi-cylindrical channels cooperate to define a first bore for snugly receiving a ferrule encasing a fiber strand;
a plunger mounted to move between a retracted position and an advanced position, the plunger including a second bore;
a lever mounted for movement between an open position and a closed position, wherein movement of the lever from the open position to the closed position imparts movement to the plunger from the retracted position to the advanced position; and
movement of the plunger from the retracted position to the advanced position moves the second bore from alignment with the first bore to out of alignment with the first bore.

18. The fiber strand preparation tool of claim 17, wherein the plunger is flanked by the jaws.
